(19) United States
(12) Patent Application Publication
(10) Pub. No.: US 2008/0175970 A1
(43) Pub. Date: Jul. 24, 2008

(54) AMINO ACID-CONTAINING ACIDIC BEVERAGE AND A METHOD FOR MANUFACTURING THE SAME

(75) Inventors: Saeko KOBAYASHI, Kawasaki-shi (JP); Yasuyuki Tomiyama, Kawasaki-shi (JP); Kazuyuki Abe, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: AJINOMOTO CO., INC., Tokyo (JP)

(21) Appl. No.: 12/036,543

(22) Filed: Feb. 25, 2008

Related U.S. Application Data
(63) Continuation of application No. PCT/JP2006/316821, filed on Aug. 22, 2006.

(30) Foreign Application Priority Data
Aug. 24, 2005 (JP) 2005-242974

(51) Int. Cl. A23L 2/68; A23L 2/38; A23L 2/60; A23L 2/66

(52) U.S. Cl. 426/548; 426/590

(57) ABSTRACT

[Problems] To provide an amino acid-containing acidic beverage having a good acidic taste and also to provide a method for manufacturing the same.

[Solving Means] Phosphoric acid and organic acid are used together as acidulating agents.

### TECHNICAL FIELD

The present invention relates to an amino acid-containing acidic beverage having a good acidic taste and to a method for manufacturing the same.

### BACKGROUND ART

With regard to an acidic beverage, that where pH is 2.5 to 4.0 is common and, since its refreshing taste is favored by consumers, considerably many commercial products thereof have been put into the market. Moreover, in recent years, various physiological functions of amino acids have been made clear and usefulness of amino acids has been receiving public attention and, under such circumstances, many amino acid-containing beverages have been put into the market. Particularly, arginine which is a basic amino acid and branched-chain amino acids (such as leucine, isoleucine and valine) have been added to sports drinks, functional beverages, acidic beverages, etc.

When a basic amino acid such as arginine is to be contained in a beverage, it is necessary to use a lot of an acidulating agent for making the pH 2.5 to 4.0. When a branched-chain amino acid is to be contained, it is also necessary to use a lot of acidulating agent in view of the characteristics of a titration curve of the amino acid since the branched-chain amino acid is a neutral amino acid. Incidentally, with regard to an acidulating agent used for common acidic beverages, citric acid is often used due to its refreshing and strong acidic taste and the present inventors have found that, when only citric acid is used for the manufacture of acidic beverages containing a basic amino acid and/or a branched-chain amino acid, it is necessary to use a lot of citric acid whereby an acidic taste is generated to such an extent that is not favorable from an organoleptic view.

Most of the investigations up to now for amino acid-containing acidic beverages are to solve the problems caused by bitter taste, abnormal taste and low solubility of amino acid and no investigation have been carried out for the above-mentioned problems of acidic taste of amino acid-containing acidic beverages. For example, the Patent Document 1 (JP-A-2003-235512) discloses a method for reducing the bitter taste of beverages containing a branched-chain amino acid; the Patent Document 2 (JP-A-2003-169642) discloses an arginine-containing beverage to which citric acid is added; and the Patent Document 3 (JP-A-2001-145) discloses an acidic beverage containing arginine and a branched-chain amino acid to which citric acid is added. However, none of them discloses the problem of acidic taste of amino acid-containing acidic beverages at all.

### DISCLOSURE OF THE INVENTION

An object of the present invention is to provide an amino acid-containing acidic beverage having a good acidic taste and also to provide a method for manufacturing the same.

In order to solve the above problem, the present inventors have carried out intensive investigations and found that an amino acid-containing acidic beverage having a good acidic taste is able to be prepared when phosphoric acid and an organic acid are used together. Thus, the invention is as follows.

(1) A method for the manufacture of an amino acid-containing acidic beverage, characterized in that, a basic amino acid and/or a branched-chain amino acid are/is added as amino acid(s) and phosphoric acid and an organic acid are added as acidulating agents.

(2) The method according to (1), wherein the adding amount of phosphoric acid is such an amount that the pH of the section where an organic acid is removed from the original material section of the amino acid-containing acidic beverage is made 5 to 7.

(3) The method according to (1) or (2), wherein the organic acid is citric acid or malic acid.

(4) The method according to (3), wherein the adding amount of phosphoric acid to 1 part by weight of citric acid or malic acid is 0.1 to 7 part(s) by weight.

(5) An amino acid-containing acidic beverage which is manufactured by the method mentioned in any of (1) to (4).

The advantage of the invention is that an amino acid-containing beverage having a good acidic taste is able to be prepared.

### BEST MODE FOR CARRYING OUT THE INVENTION

The acidic beverage of the invention includes not only a liquid one but also gel-like and semi-solid ones such as a so-called jelly beverage. The pH of the acidic beverage of the invention is not higher than 6.5 and, preferably, it is 2 to 4 or, more preferably, it is 2.5 to 4.0.

There is no particular limitation for sources and manufacturing methods of the basic amino acid and the branched-chain amino acid of the invention so far as they are in a grade for foods. Although there is no limitation for the concentration of the amino acid, when the concentration of the basic amino acid and the branched-chain amino acid becomes higher, the adding amount of the acidulating agent necessary for lowering the pH becomes more whereby the advantages of the invention are available more significantly. In general, the amino acid concentration of the amino acid-containing acidic beverage in terms of the sum of the basic amino acid and the branched-chain amino acid is preferably 0.1 to 7 g/100 ml, more preferably 0.2 to 4 g/100 ml and, still more preferably, 0.2 to 2 g/100 ml.

There is no particular limitation for the organic acid of the invention so far as it is able to be used for foods and there is also no problem whether water of crystallization is present or absent. Examples thereof are citric acid, malic acid, lactic acid and ascorbic acid. There is also no limitation how and when it is to be added to the beverage. Liquid or crystalline one may be added or a state of a solution being dissolved in a solvent such as water may be added as well.

There is no particular limitation for a source and a manufacturing method of the phosphoric acid of the invention so far as it is in a grade for foods. There is also no limitation how and when it is to be added to the beverage. Liquid or crystalline one may be added or a state of a solution being dissolved in a solvent such as water may be added as well.

The expression in the invention that the adding amount of phosphoric acid is such an amount that the pH of the section where an organic acid is removed from the original material section of the amino acid-containing acidic beverage is made 5 to 7 means that the amount of phosphoric acid is such an amount that the pH of the section where an organic acid is removed from the original material section including water of the amino acid-containing acidic beverage is made 5 to 7. It is a matter of course that the amount of phosphoric acid varies depending upon the material composition in the beverage such as the amount of the basic amino acid and the optimum adding amount of phosphoric acid is able to be easily determined in advance by such a means that, for example, phosphoric acid is added little by little together with measurement of the pH of the section excluding the organic acid.

Although there is no particular restriction for the ratio of adding amount of phosphoric acid to that of citric acid or malic acid in the invention, the ratio in terms of (phosphoric acid):(citric acid) by weight is preferably 1:(0.1 to 7), more preferably 1:(0.3 to 5.6) and, still more preferably, 1:(0.4 to 5.6). Further, the ratio in terms of (phosphoric acid):(malic acid) by weight is preferably 1:(0.1 to 7), more preferably 1:(0.4 to 6.5) and, still more preferably, 1:(0.4 to 6.4).

Examples of suitable basic amino acids include arginine, lysine, and histidine. Examples of suitable branched-chain amino acid include leucine, isoleucine, and valine. In a preferred embodiment, the beverage contains one or more amino acids selected from the group consisting of arginine, leucine, isoleucine, and valine. In another preferred embodiment, the beverage contains arginine. In another preferred embodiment, the beverage contains arginine, leucine, isoleucine, and valine.

Typically, the beverage will contain the organic acid in an amount of 0.1 to 1.5 g/100 ml, preferably 0.3 to 1.3 g/100 ml, more preferably 0.5 to 1 g/100 ml, based on the total volume of the beverage.

In another embodiment, the beverage may also contain one or more sweeteners. Suitable sweeteners for inclusion in the beverage include sucrose, glucose, high fructose corn syrup, saccharin, aspartame, acesulfame K, neotame, and mixtures thereof.

In another embodiment, the beverage may also contain one or more electrolytes. Suitable electrolytes include calcium phosphate, dipotassium hydrogen phosphate, sodium hydrogen phosphate, sodium citrate, sodium lactate, sodium chloride, potassium chloride, calcium chloride, magnesium chloride, magnesium sulfate, zinc sulfate, and magnesium carbonate. Of course, these electrolytes may be used singly or in combination. Typically, the beverage will contain the electrolytes in a total amount of 0.05 to 1 wt. %, preferably 0.075 to 0.75 wt. %, more preferably 0.1 to 0.5 wt. %, based on the total weight of said beverage.

The beverage may be either a carbonated beverage or a non-carbonated beverage.

### EXAMPLES

The invention will now be illustrated in more detail by way of the following Examples. The invention is not limited by those Examples at all.

### Example 1

A 20% aqueous solution of phosphoric acid was added to the solutions of amino acids and sugar having the compositions as shown in Table 1, Table 2 and Table 3 so that the pH of the amino acid-containing solution is adjusted to from 3.5 to 7 and then the pH was adjusted to 3.5 by addition of a 20% aqueous solution of citric acid or a 20% aqueous solution of malic acid and ion-exchange water to prepare the amino-acid containing acidic beverage each being 100 ml. Each of the resulting amino acid-containing acidic beverages was subjected to an organoleptic evaluation by two professional panelists. Result of the organoleptic evaluation is shown in Table 4. As shown in Table 4, the acidic taste was strongly expressed and that was not favorable in an organoleptic view when pH was lowered by citric acid or malic acid while, when phosphoric acid was used together with such an organic acid, expression of the acidic taste was not too strong but a good acidic taste was resulted. When the pH was lowered by phosphoric acid only, the acidic taste was too weak and that was not favorable as an acidic beverage.

TABLE 1

| | Comparative | Comparative | Comparative | Invention | Invention | Invention | Invention | Invention | Invention |
|---|---|---|---|---|---|---|---|---|---|
| | Product 1 | Product 2 | Product 3 | Product 1 | Product 2 | Product 3 | Product 4 | Product 5 | Product 6 |
| Arg (g) | 1.0 | 1.0 | 1.0 | 1.0 | 1.0 | 1.0 | 1.0 | 1.0 | 1.0 |
| Sugar (g) | 8.0 | 8.0 | 8.0 | 8.0 | 8.0 | 8.0 | 8.0 | 8.0 | 8.0 |
| 20% Citric Acid (g) | 7.08 | — | — | 3.13 | 1.49 | 0.59 | — | — | — |
| 20% Malic Acid (g) | — | 5.93 | — | — | — | — | 2.70 | 1.34 | 0.50 |
| 20% Phosphoric | — | — | 3.50 | 1.94 | 2.77 | 3.28 | 1.89 | 2.74 | 3.22 |
| Acid Soln (g) | | | | | | | | | |
| Ion-Exchange | Added to Make Total Volume 100 ml | | | | | | | | |
| Water | | | | | | | | | |
| pH after Addition of | — | — | 3.5 | 7.0 | 6.0 | 5.0 | 7.0 | 6.0 | 5.0 |
| Phosphoric Acid | | | | | | | | | |
| Final pH of the | 3.5 | 3.5 | 3.5 | 3.5 | 3.5 | 3.5 | 3.5 | 3.5 | 3.5 |
| Sample | | | | | | | | | |

TABLE 2

| | Comparative | Comparative | Invention | Invention | Invention | Invention | Invention | Invention |
|---|---|---|---|---|---|---|---|---|
| | Product 4 | Product 5 | Product 7 | Product 8 | Product 9 | Product 10 | Product 11 | Product 12 |
| Arg (g) | 1.0 | 1.0 | 1.0 | 1.0 | 1.0 | 1.0 | 1.0 | 1.0 |
| Leu (g) | 1.0 | 1.0 | 1.0 | 1.0 | 1.0 | 1.0 | 1.0 | 1.0 |
| Ile (g) | 1.0 | 1.0 | 1.0 | 1.0 | 1.0 | 1.0 | 1.0 | 1.0 |
| Val (g) | 1.0 | 1.0 | 1.0 | 1.0 | 1.0 | 1.0 | 1.0 | 1.0 |
| Sugar (g) | 8.0 | 8.0 | 8.0 | 8.0 | 8.0 | 8.0 | 8.0 | 8.0 |
| 20% Citric Acid (g) | 9.25 | — | 5.40 | 3.72 | 2.77 | — | — | — |
| 20% Malic Acid (g) | — | — | — | — | — | 4.74 | 3.16 | 2.32 |
| 20% Phosphoric | — | 4.63 | 1.93 | 2.78 | 3.27 | 1.91 | 2.76 | 3.24 |
| Acid Soln (g) | | | | | | | | |
| Ion-Exchange | Added to Make Total Volume 100 ml | | | | | | | |
| Water | | | | | | | | |
| pH after Addition of | — | 3.5 | 7.0 | 6.0 | 5.0 | 7.0 | 6.0 | 5.0 |
| Phosphoric Acid | | | | | | | | |
| Final pH of the | 3.5 | 3.5 | 3.5 | 3.5 | 3.5 | 3.5 | 3.5 | 3.5 |
| Sample | | | | | | | | |

TABLE 3

| | Comparative | Comparative | Invention | Invention | Invention |
|---|---|---|---|---|---|
| | Product 6 | Product 7 | Product 13 | Product 14 | Product 15 |
| Arg (g) | 0.25 | 0.25 | 0.25 | 0.25 | 0.25 |
| Leu (g) | 0.25 | 0.25 | 0.25 | 0.25 | 0.25 |
| Ile (g) | 0.25 | 0.25 | 0.25 | 0.25 | 0.25 |
| Val (g) | 0.25 | 0.25 | 0.25 | 0.25 | 0.25 |
| Sugar (g) | 8.0 | 8.0 | 8.0 | 8.0 | 8.0 |
| 20% Citric Acid (g) | 2.41 | — | 1.32 | 0.99 | 0.63 |
| 20% Phosphoric Acid | — | 1.13 | 0.53 | 0.74 | 0.83 |
| Soln (g) | | | | | |
| Ion-Exchange Water | Added to Make Total Volume 100 ml | | | | |
| pH after Addition of | — | 3.5 | 7.0 | 6.0 | 5.0 |
| Phosphoric Acid | | | | | |
| Final pH of the | 3.5 | 3.5 | 3.5 | 3.5 | 3.5 |
| Sample | | | | | |

TABLE 4

| | Organoleptic Evaluation | Total Evaluation |
|---|---|---|
| Comparative Product 1 | Unfavorable due to too strong acidic taste | x |
| Comparative Product 2 | Unfavorable due to too strong acidic taste | x |
| Comparative Product 3 | Unfavorable due to too weak acidic taste | x |
| Invention Product 1 | Good due to appropriate intensity of acidic taste | oo |
| Invention Product 2 | Good due to appropriate intensity of acidic taste | oo |
| Invention Product 3 | Good due to appropriate intensity of acidic taste | oo |
| Invention Product 4 | Good although acidic taste was somewhat strong | o |
| Invention Product 5 | Good although acidic taste was somewhat strong | o |
| Invention Product 6 | Good although acidic taste was somewhat weak | o |
| Comparative Product 4 | Unfavorable due to too strong acidic taste | x |
| Comparative Product 5 | Unfavorable due to too weak acidic taste | x |
| Invention Product 7 | Within permissible range although acidic taste was strong | Δ |
| Invention Product 8 | Good although acidic taste was somewhat strong | o |
| Invention Product 9 | Good due to appropriate intensity of acidic taste | oo |
| Invention Product 10 | Within permissible range although acidic taste was strong | Δ |
| Invention Product 11 | Good although acidic taste was somewhat strong | o |
| Invention Product 12 | Good although acidic taste was somewhat strong | o |
| Comparative Product 6 | Unfavorable due to too strong acidic taste | x |
| Comparative Product 7 | Unfavorable due to too weak acidic taste | x |
| Invention Product 13 | Good due to appropriate intensity of acidic taste | oo |
| Invention Product 14 | Good due to appropriate intensity of acidic taste | oo |
| Invention Product 15 | Good due to appropriate intensity of acidic taste | oo |

oo: Acidic taste was good
o: Good although acidic taste was somewhat strong or somewhat weak
Δ: Within a permissible range as an acidic beverage although acidic taste was strong or weak
x: Unfavorable as an acidic beverage since acidic taste was too strong or too weak

### INDUSTRIAL APPLICABILITY

It is now possible in accordance with the invention to prepare an amino acid-containing acidic beverage having a good acidic taste whereby the invention is very useful in the field of beverages.

1. A method for making an amino acid-containing acidic beverage, comprising:
mixing:
(a) at least one basic amino acid and/or at least one branched-chain amino acid;
(b) phosphoric acid; and
(c) at least one organic acid.

2. The method according to claim 1, wherein said phosphoric acid is mixed in an amount such that the pH of said beverage in the absence of said organic acid would be in the range of 5 to 7.

3. The method according to claim 1, wherein said at least one organic acid is selected from the group consisting of citric acid, malic acid, and a mixture thereof.

4. The method according to claim 2, wherein said at least one organic acid is selected from the group consisting of citric acid, malic acid, and a mixture thereof.

5. The method according to claim 3, wherein said phosphoric acid is mixed in an amount of 0.1 to 7 parts by weight per 1 part by weight of said at least one organic acid.

6. The method according to claim 4, wherein said phosphoric acid is mixed in an amount of 0.1 to 7 parts by weight per 1 part by weight of said at least one organic acid.

7. The method according to claim 1, wherein said at least one basic amino acid and/or at least one branched-chain amino acid is selected from the group consisting of arginine, lysine, histidine, leucine, isoleucine, valine, and a mixture thereof.

8. The method according to claim 1, wherein said at least one basic amino acid and/or at least one branched-chain amino acid is selected from the group consisting of arginine, leucine, isoleucine, valine, and a mixture thereof.

9. An amino acid-containing acidic beverage, which is obtainable by a method according to claim 1.

10. An amino acid-containing acidic beverage, comprising:
(a) at least one basic amino acid and/or at least one branched-chain amino acid;
(b) phosphoric acid; and
(c) at least one organic acid.

11. The beverage according to claim 10, wherein said phosphoric acid is present in an amount such that the pH of said beverage in the absence of said organic acid would be in the range of 5 to 7.

12. The beverage according to claim 10, wherein said at least one organic acid is selected from the group consisting of citric acid, malic acid, and a mixture thereof.

13. The beverage according to claim 12, wherein said phosphoric acid is present in an amount of 0.1 to 7 parts by weight per 1 part by weight of said at least one organic acid.

14. The beverage according to claim 10, wherein said at least one basic amino acid and/or at least one branched-chain amino acid is selected from the group consisting of arginine, lysine, histidine, leucine, isoleucine, valine, and a mixture thereof.

15. The beverage according to claim 10, wherein said at least one basic amino acid and/or at least one branched-chain amino acid is selected from the group consisting of arginine, leucine, isoleucine, valine, and a mixture thereof.

16. The beverage according to claim 10, which comprises said at least one basic amino acid and/or at least one branched-chain amino acid in a total amount of 0.1 to 7 g/100 ml, based on the total volume of said beverage.

17. The beverage according to claim 10, which has a pH of not higher than 6.5.

18. The beverage according to claim 10, which has a pH of 2 to 4.

19. The beverage according to claim 10, which comprises said at least one organic acid in an amount of 0.1 to 1.5 g/100 ml, based on the total volume of said beverage.

20. The beverage according to claim 10, which further comprises at least one sweetener.

21. The beverage according to claim 20, wherein said at least one sweetener is selected from the group consisting of sucrose, glucose, high fructose corn syrup, saccharin, aspartame, acesulfame K, neotame, and a mixture thereof.

22. The beverage according to claim 10, which further comprises at least one electrolyte.

23. The beverage according to claim 23, wherein said at least one electrolyte is selected from the group consisting of calcium phosphate, dipotassium hydrogen phosphate, sodium hydrogen phosphate, sodium citrate, sodium lactate, sodium chloride, potassium chloride, calcium chloride, magnesium chloride, magnesium sulfate, zinc sulfate, magnesium carbonate, and a mixture thereof.

24. The beverage according to claim 23, which comprises said at least one electrolyte in a total amount of 0.05 to 1 wt. %, based on the total weight of said beverage.

25. The beverage according to claim 10, which is a carbonated beverage.

26. The beverage according to claim 10, which is not a carbonated beverage.
